(19) United States
(12) Patent Application Publication
(10) Pub. No.: US 2005/0184494 A1
(43) Pub. Date: Aug. 25, 2005

(54) Curtain airbag with cascade inflator

(75) Inventor: Yoshiaki Sakata, Hikone-shi (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/062,656

(22) Filed: Feb. 23, 2005

Related U.S. Application Data
(60) Provisional application No. 60/546,953, filed on Feb. 24, 2004.

(51) Int. Cl. B60R 21/24; B60R 21/22; B60R 21/26

(52) U.S. Cl. 280/730.2; 280/729; 280/736

(57) ABSTRACT

An airbag device with a curtain airbag mounted along the roof line of the vehicle and a cascade type inflator. The inflator is divided into sections and positioned along the length of the airbag. The divided inflator eliminates the need to bend or contort the inflator when installed in a vehicle. Deployment of the airbag is controlled by a controller.

### CROSS REFERENCE TO RELATED APPLICATIONS

This application claims priority to and the benefit of U.S. Provisional Application No. 60/546,953, filed Feb. 24, 2004.

### BACKGROUND

The present invention relates to an airbag device comprising a curtain airbag.

Airbags are used as safety devices in vehicles. It is well known to provide airbags to protect an occupant during a head-on or broadside collision. Conventional airbags inflate upon sensing predetermined conditions such as an impact or sudden deceleration.

Conventional airbags may be positioned along the roof rail line of a vehicle so that the airbag may inflate in a downwardly direction in a curtain like manner. Such conventional curtain airbags protect an occupant's head during a broadside collision. Conventional curtain airbags generally inflate rapidly away from the roof rail line between the occupants and the vehicle side adjacent to the occupants.

Generally, conventional airbags are inflated by an inflator which fills the airbag with a gas upon the sensing of a predetermined condition. Conventional airbag inflators are positioned at an end of the airbag adjacent the rear end portion of the vehicle. A drawback of such conventional airbag inflator setup is that it is difficult to quickly and uniformly inflate and deploy the airbag. Generally, conventional curtain airbags are long and narrow which increases the difficulty in uniformly inflating the airbag.

In an attempt to increase the efficiency of the inflation, curtain airbags have been developed to include certain non-inflated areas, as can be seen for example in U.S. Pat. No. 6,530,595 (hereby incorporated by reference herein in its entirety). Curtain airbags devices may include pipe or conduit to distribute the inflation gases within the airbag, increasing the cost and labor required to install such airbag devices.

In other instances, curtain airbags may include an extended inflator that is bent in order to position the inflator properly within the airbag. These bent inflators must generally be tailored for each specific vehicle, which is generally a significant cost. Furthermore, the lengthy inflators may be heavy and cumbersome, making installation time-consuming and difficult.

### SUMMARY OF THE INVENTION

According to one embodiment of the present invention, an airbag device is provided. The airbag device includes a curtain airbag configured to deploy along an interior side of a vehicle and an inflator. The inflator includes a plurality of separate cascade inflators positioned along a length of the airbag.

According to another embodiment of the present invention, an airbag device is provided. The airbag device includes a plurality of airbags and a cascade inflator. The cascade inflator is divided into sections and each section is positioned inside a separate airbag.

According to another embodiment of the present invention, an airbag device is provided. The airbag device includes a seat-mounted airbag configured to deploy along a side of a seat and an inflator. The inflator includes a plurality of separate cascade inflators positioned along a length of the airbag.

It is to be understood that both the foregoing general description and the following detailed description are exemplary and explanatory only, and are not restrictive of the invention as claimed.

### BRIEF DESCRIPTION OF DRAWINGS

These and other features, aspects, and advantages of the present invention will become apparent from the following description, appended claims, and the accompanying exemplary embodiments shown in the drawings, which are briefly described below.

FIG. 1 is a sectional view of an airbag device according to an embodiment of the present invention.

FIG. 2 is a cross-sectional view of line I-II of the airbag device of FIG. 1.

FIG. 3 is a view of the airbag device of FIG. 1.

FIG. 4 is a sectional view of an airbag device of another embodiment of the present invention.

FIG. 5 is a view of the airbag device of FIG. 4.

FIG. 6 is a cross-sectional view of line I′-II′ of the airbag device of FIG. 4.

FIG. 7 is view of an airbag device of another embodiment of the present invention.

FIG. 8 is a view of an airbag device of another embodiment of the present invention.

FIG. 9 is a perspective view of an airbag device of another embodiment of the present invention.

FIG. 10 is a schematic view of another embodiment of the present invention.

### DETAILED DESCRIPTION

Hereinafter, embodiments of the present invention will be described with reference to the attached drawings.

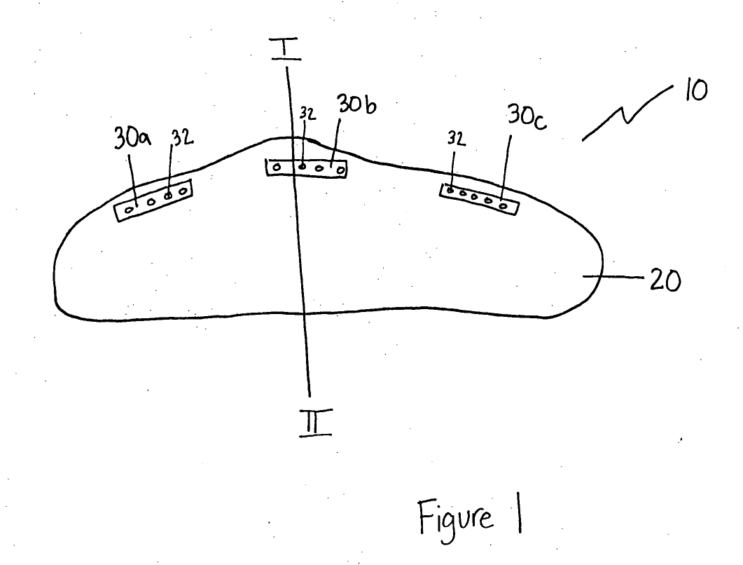

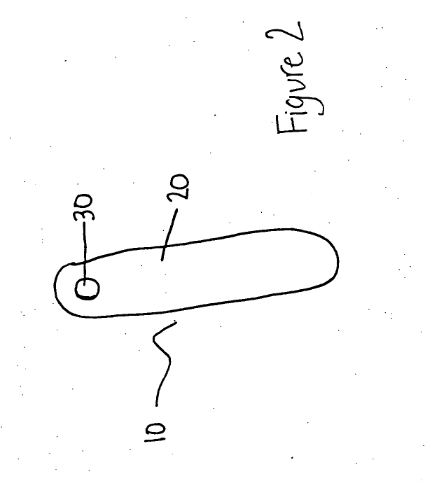

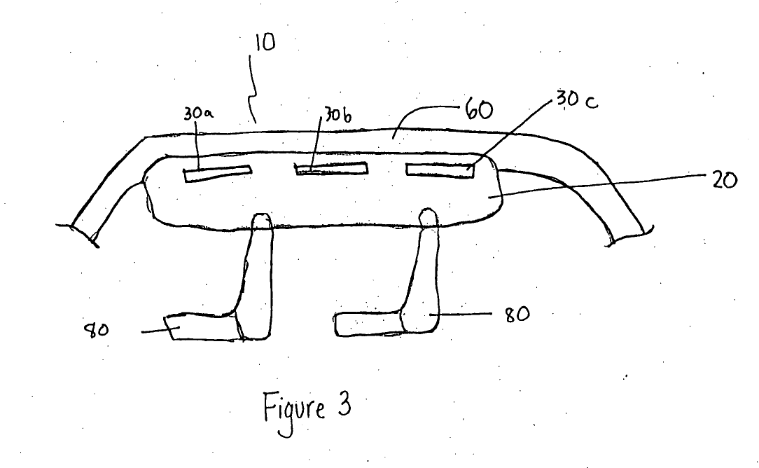

An airbag device 10 of an embodiment of the present invention is shown in FIGS. 1-3. The airbag device includes an airbag 20 and a inflator 30. The airbag 20 is a curtain airbag, disposed between the roofline 60 of a vehicle and an occupant. The curtain airbag 20 may be mounted along the roof line 60 of the vehicle.

The curtain airbag 20 is configured to deploy down from the roof line 60 of the vehicle and inflate between a side portion of the vehicle near an occupant and the occupant. The curtain airbag 20 is configured to provide protection for the occupant along the side of the vehicle between the front and rear pillars of the vehicle.

The airbag device 10 includes an inflator 30 positioned inside of the airbag 20. The inflator is preferably a cascade type inflator. An exemplary cascade type inflator is disclosed in the PCT published application WO 00/32447 (incorporated by reference herein). Inflation gases flow from the inflator 30, out along the length of the inflator 30 and at substantially the same rate. The inflator 30 restricts the flow of the inflation gases to a desired rate, direction and pressure.

The present invention also includes an embodiment of an inflator containing a gas generant or propellant. According to yet another embodiment the inflator may contain a decomposing type material as the source of the pressurized gas for the airbag.

Each inflator may contain a gas generant or propellant 300. Each inflator may also contain a standard igniter or initiator assembly. The igniter receives a signal from a firing circuit or controller in order to initiate operation of the inflator.

The propellant charge or gas generant may extend for all or most of the length of the inflator thereby facilitating a substantially uniform gas generation once the propellant is ignited. The propellant material may be selected from known propellants such as disclosed in U.S. Patent Application Publication 2001/0045735 A1 (incorporated by reference herein in its entirety).

The inflator 30 may have a series of holes 32 to serve as exhaust ports which control release of the inflation gases produced by the inflator 30. The inflator 30 includes a propellant for generating the inflation gases when activated by an ignition assembly.

The inflator 30 is divided. That is, the inflator 30 is divided to include different sections within the airbag. The divided inflator 30 may have three sections 30a, 30b, 30c located along the length of the airbag 20 at varying intervals. However, the number of sections of the divided inflator 30 may vary. For instance, there may be two sections or there may be four sections of the divided inflator 30. By dividing the inflator 30, the inflator 30 may not have to be bent in order to position the inflator 30 within the airbag 20 and mount the airbag device 10 in a vehicle.

The divided inflator 30 may be mounted along the roof line 60 of the vehicle.

Ignition of the inflator 30 is activated upon the sensing of predetermined conditions. A seat weight sensor (not shown) is generally disposed in the vehicle seat 80 and determines the weight of an occupant, and may also determine other conditions, such as location and position in the seat 80. Output from the seat weight sensor controls the status of the airbag 20 inflation, thus determining the rate of deployment and force required to protect the occupant.

A controller or electronic control unit (ECU) 50 may be utilized to control the deployment of the airbag, as can be seen in FIG. 1. The ECU 50 may receive input or information from a variety of sources. For example, the scope of the present invention includes detecting the status of the vehicle occupants using a seat weight sensor, a Motorized Seat Belt (MSB), a sensor for measuring the pulled out length of a seat belt webbing, a proximity sensor (e.g., capacitance type), a CCD camera, an optical sensor, an ultrasonic type sensor, a magnetic field sensor, a 3D scan system, an acceleration system or any other sensor that can detect the status of the occupant. The status of the occupants can be provided to the ECU 50.

The ECU 50 also may receive inputs from other sensors and/or systems to determine the status of the vehicle and the conditions in which the vehicle is operating. For example, the ECU 50 may receive additional input from a pre-crash sensor, a front or side impact sensor, a MSB, a proximity sensor, an acceleration sensor, a GPS navigation system, a system for monitoring the conditions outside the vehicle such as weather or lighting (e.g., day or night conditions); or any other sensor or system that may be suitable for detecting conditions affecting the vehicle such as an approaching object, vehicle or pedestrian.

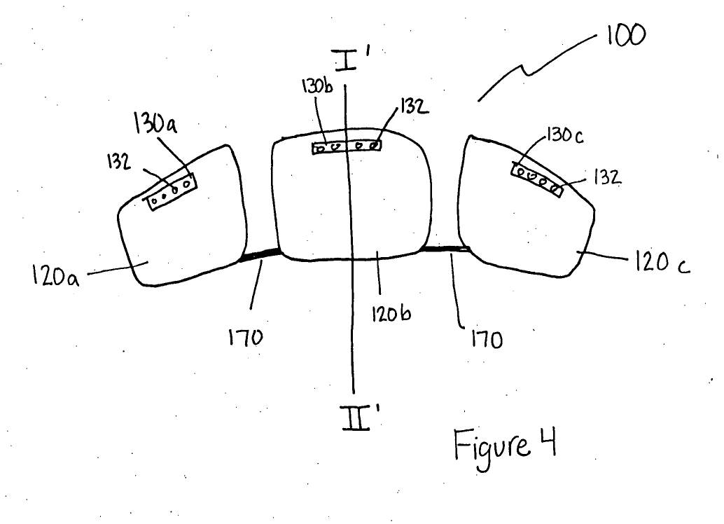

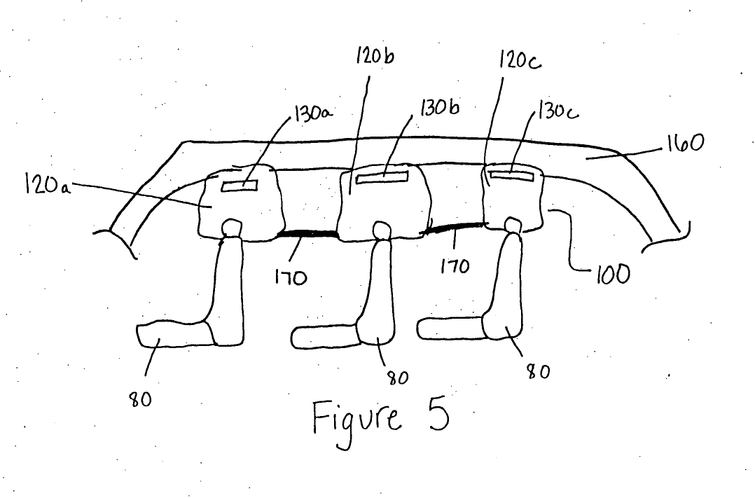

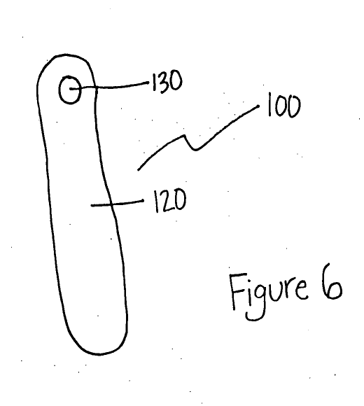

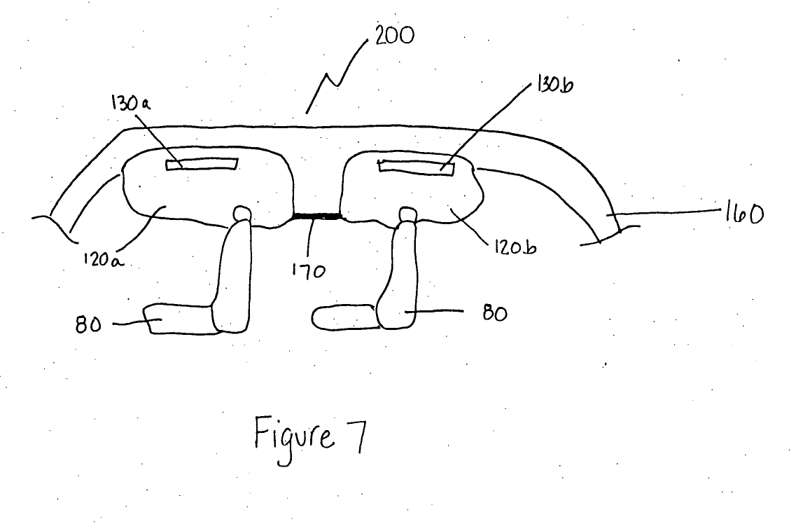

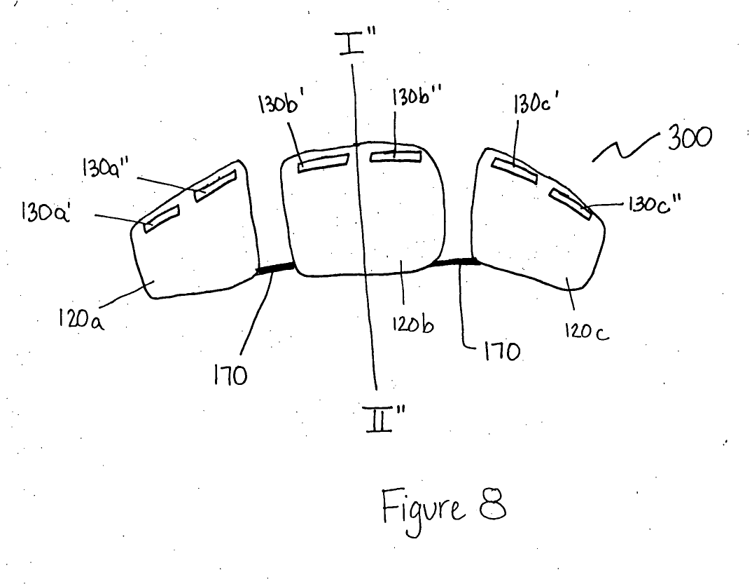

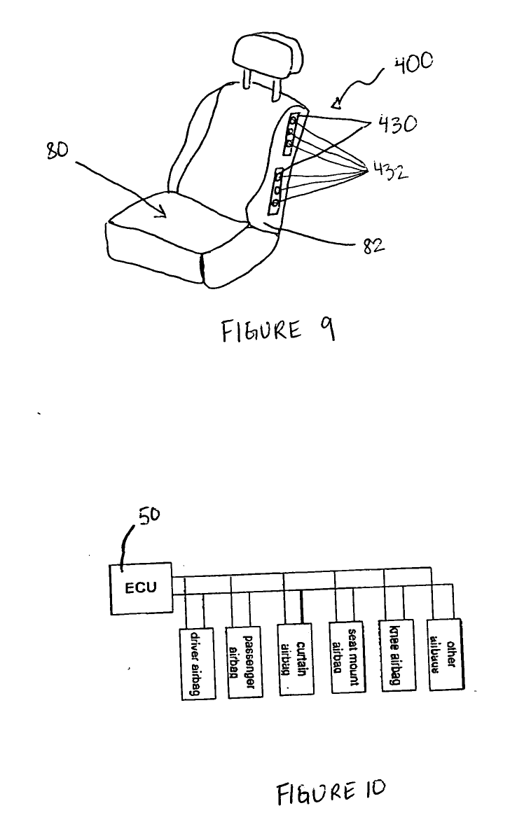

The ECU 50 signals the ignition assembly that the airbag 20 should be deployed upon sensing predetermined conditions, such as sudden deceleration or an impact. The ECU 50 may also receive information from various sensors regarding the status or position of the occupant. The ECU 50 and the various sensors and systems described above may be included in the exemplary embodiments shown in FIGS. 4-9.

In another embodiment of the invention, each airbag device 10, 100, 200, 300, 400 can be controlled by a single ECU 50, such as shown in FIG. 10. The ECU 50 can control a driver, passenger, curtain, seat-mounted, knee or other airbag device. Additionally, the ECU 50 can control a seat belt retractor or pretensioner (not shown) or any other safety device installed in a vehicle.

The ECU 50, via a BUS system shown in FIG. 10, sends signals to the airbag devices and their respective inflators to deploy a particular device, a combination of devices, or all of the airbag devices. The ECU 50 determines which cascade inflator should be ignited during a crash event based on occupant and vehicle status.

FIGS. 4-6 show an alternative embodiment in which the airbag device 100 may have a plurality of airbags 120. The airbag device may provide coverage to occupants in seats of three rows. That is, the airbag 120a protects an occupant in a first row, airbag 120b protects an occupant in a second row, and airbag 120c protects an occupant in a third row.

The airbags 120a-120c may be joined by a connecting strip 170. The connecting strip 170 joins the airbags 120a-120c at a bottom side of each airbag 120a-120c (in the vehicle floor direction when the airbags are deployed). The airbags 120a-120c may be folded separately and arranged with each other and in the final stage of assembly the connecting strip 170 is attached to join the airbags 120a-120c together.

The airbag device includes an inflator 130. The inflator is preferably a cascade type inflator as described above. Each airbag 120a-120c includes a separate inflator 130a-130c. The sections 130a-130c of the inflator 130 may include a series of holes 132 to serve as exhaust ports. The holes 132 control the release of the inflation gases produced by the inflator 130a-130c. Ignition of the inflator and, thus, each section of the divided inflator, is controlled by the ECU 50. The ECU 50 may operate as described above with regard to FIGS. 1-3.

In another embodiment of the present invention, as shown in FIG. 7, the airbag device 200 may comprise two airbags 120a, 120b for protecting occupants seated in two rows. The deployment of each airbag may be separately controlled by the ECU 50. The airbag device 200 may include any other suitable number of airbags 120 for protection of an occupant in a vehicle. The scope of the present invention includes separately controlling each of the inflator.

In an alternative embodiment shown in FIG. 7, the inflator 130 may be divided into different sections 130a′, 130a″, 130b′, 130b″, 130c′, 130c″ within each airbag 120a-120c. Further, any suitable number of sections may be installed within the airbag device 300 for proper inflation of the airbag 120a-120c.

Dividing the inflator enables the inflator to be small and light in weight. Further, the inflator may be mounted in a variety of vehicle models.

In another embodiment shown in FIG. 9, the airbag device 400 is a seat-mounted side airbag positioned along a side 82 of an occupant seat 80. A divided inflator 430 with multiple cascade inflators can be positioned along the side 82 of the seat 80. The airbag device 400 can include a single airbag or multiple, connected airbags that inflate along a side 82 of the seat 80, between the occupant and an interior wall of a vehicle (the door side of a vehicle).

The multiple airbags can be connected as shown above in the embodiment of FIGS. 4-6. Alternatively, the single airbag can be connected as shown in the embodiment of FIGS. 1-3. The inflator 430 can also include a series of holes 432 to serve as exhaust ports. The exhaust ports 432 control release of the inflation gases of the inflator 430. The cascaded, multiple inflators 430 can be positioned in a single airbag. Multiple airbags can be used with different, linked inflators 430.

According to another embodiment, any combination of embodiments can be employed in the airbag device.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. An airbag device, comprising:
a curtain airbag configured to deploy along an interior side of a vehicle and an inflator;
wherein the inflator includes a plurality of separate cascade inflators positioned along a length of the airbag.

2. The airbag device according to claim 1, further comprising a controller that controls the deployment of the airbag.

3. The airbag device of claim 2, wherein the controller sends a separate initiation signal to each cascade inflator.

4. The airbag device according to claim 1, wherein the airbag device is mounted along the roof line of a vehicle.

5. The airbag device according to claim 1, wherein each of the cascade inflators are linear.

6. An airbag device, comprising:
a plurality of airbags and a corresponding number of inflators, wherein each inflator is a cascade inflator and is positioned to inflate one of the plurality of airbags.

7. The airbag device according to claim 6, further comprising a connecting strip connects each of the plurality of airbags to another one of the plurality of airbags.

8. The airbag device according to claim 6, wherein the airbag device is mounted along the roof line of a vehicle.

9. The airbag device according to claim 6, further comprising a controller that controls the deployment of each of the airbags.

10. The airbag device of claim 9, wherein the controller sends a separate signal to each of the plurality of inflators in order to initiate inflation of each airbag.

11. The airbag device of claim 6, wherein the airbag device is mounted in a side of a seat in a vehicle.

12. An airbag device, comprising:
a seat-mounted airbag configured to deploy along a side of a seat; and
an inflator,
wherein the inflator includes a plurality of separate cascade inflators positioned along a length of the airbag.

13. The airbag device according to claim 12, further comprising a controller that controls the deployment of the airbag.

14. The airbag device of claim 13, wherein the controller sends a separate initiation signal to each cascade inflator.

15. The airbag device according to claim 12, wherein each of the cascade inflators are linear.
